(19) United States
(12) Patent Application Publication
(10) Pub. No.: US 2008/0057773 A1
(43) Pub. Date: Mar. 6, 2008

(54) Connecting element for the connection of electronic leads

(75) Inventors: Robert Ingenbleek, Kressbronn (DE); Thomas Bock, Friedrichshafen (DE); Michael Schwab, Markdorf (DE); Marc Abele, Uberlingen (DE)

Correspondence Address: DAVIS BUJOLD & Daniels, P.L.L.C., 112 PLEASANT STREET, CONCORD, NH, 03301, US

(73) Assignee: ZF Friedrichshafen AG, Friedrichshafen (DE)

(21) Appl. No.: 11/847,396

(22) Filed: Aug. 30, 2007

(30) Foreign Application Priority Data
Aug. 31, 2006 (DE) 10 2006 040 815.2
Jul. 6, 2007 (DE) 10 2007 031 727.3

(51) Int. Cl. H01R 13/40; H01R 13/64

(52) U.S. Cl. 439/374

(57) ABSTRACT

Connection element for forming a permanent electric connection between a first and a second electric lead (1, 2), each being attached in fixed position to a respective first and second housing (3, 4), such that the housings have guiding means (5) which, when the housings (3, 4) are brought together, co-operate in such manner that the leads are correctly positioned for forming the electric connection and the connection forming device can act upon the electric leads (1, 2) to be connected through openings (7) in the housings.

This application claims priority from German Application Serial No. 10 2006 040 815.2 filed Aug. 31, 2006.

### FIELD OF THE INVENTION

The present invention concerns a device and method for producing a permanent, electrically conducting connection between at least two electric leads.

### BACKGROUND OF THE INVENTION

In the automobile technology numerous electronic components are used, for example in the engine or transmission control systems. They often consist of several specific structural elements connected to one another by data leads and via sensors to the surroundings, and also have energy supply leads. If these connections should fail there may be serious consequences, such as shifting difficulties or ignition failures, and for that reason they are usually made as fixed, permanent connections.

From DE 198 40 306 A1 a device is known, which brings electric conductors, in particular contact pins of an integrated electronic unit and their associated connection leads, into a defined position relative to one another, whereby the subsequent formation of the joint by laser welding is made easier. For this, the device is connected in a fixed position to a first electric lead, and together is then placed on a second electric lead, which is therefore brought to the desired position relative to the first electric lead. To counteract differences in position between the electric leads, they are also subjected to a contact pressure directed toward one another. In addition, to ensure accurate orientation of the connection forming device, the position of the second electric lead is determined in advance with the help of a measuring device.

Using the device proposed, the electric leads are connected at right-angles by the so-termed penetration welding method. Neither of the connection points of the two electric leads are freely exposed to view so checking of the quality of the connection without interference is difficult. The use of an additional measuring device is required with the connection forming device, and entails a separate process step for the measurement of the second lead. The connection point is not protected against external environmental influences, such as sprayed water or dust, as such additional devices are needed for protection.

Accordingly, the purpose of the present invention is to provide a device which positions the electric leads to be joined in such manner that a permanent electrical connection can be made therebetween in as few process steps as possible, and which at the same time overcomes the drawbacks, known from the prior art, of insufficient visibility of the connection point and difficult checking of the joint quality. In addition the device should ensure sufficient protection against external environmental influences.

### SUMMARY OF THE INVENTION

According to the invention, the electric leads to be connected, for example stamped-grid conducting paths or contact pins, are respectively held in fixed positions within housings, which can then be brought together in a defined way via guiding means. The electric leads are positioned over one another in such manner that they can be connected together to form a permanent electrically conducting joint by means of a connection forming device, preferably a laser welding unit. To protect the electric connections from external environmental influences the housings and electric leads can also be sealed with sealing means.

In one embodiment of the invention, the housings also have detent means with which the two housings can be held together after being joined, which provides additional security against the vibration and juddering movements that usually occur in motor vehicles and also has advantages in relation to an automated connection forming process, since the secure coupling of the housings eliminates the need for additional process steps or tools for fixing the housings to one another. Thus, the housings with the electric leads in their fixed positions are preferably designed to enable the housings to be brought together and the electric leads to be connected in an automated process.

Since the housings are united in a definite way and locked together and the electric leads are held in fixed positions in them, they can be freely designed and therefore adapted to the particular circumstances of the connection forming process. In an advantageous embodiment of the invention the end of the electric leads are formed into “L-shaped” bends, which are brought together and positioned by the housing guide means in such a manner that the ends make directed contact. The connection is made through openings provided in the housings, which allows free access of the connection forming device to reach the positioned ends of the electric leads, and also allows the quality of the connection to be checked.

In a further development of the invention, only the first electric lead has an “L-shaped” bend at its connecting end, while in contrast the second electric lead is straight at its connecting end. This is an advantage for many structural shapes of the housings or when limited space is available for assembly.

According to the invention, the ends of the electric leads to be positioned and connected do not need to have any particular complementary cross-section shapes as is the case, for example, with plug/socket systems. Furthermore, the surface condition or coating of the leads does not have to satisfy any particular requirements. The material used for the housings, however, must be electrically insulating or suitably electrically separated from the leads.

To protect them against harsh environmental influences, particularly sensitive control electronic units can be fitted inside a hermetically sealed housing. Such units have electric leads leading to the outside of the housing to enable connection to other electric components and the leads to ensure effective sealing, often have a circular or rounded cross-section, i.e., with no edges either along their entire length or only in the area where they pass through the housing. A glass material is often used as a sealant which, at the same time, insulates the leads from the housing wall. If the first electric lead emerging from the first housing has a rounded cross-section and the second electric lead to be connected to it has a polygonal cross-section, a particularly advantageous further development of the invention provides that the end of the first electric lead to be connected is flattened in the direction facing the second electric lead whereby, when a laser welding process is used to produce the connection, a better incidence of the laser beam on the conducting material is achieved which, in turn, improves the quality of the connection and so also the process reliability in industrial use.

When the housings are exposed to particularly severe environmental influences, the long-term quality of the connection between the electric leads cannot be ensured without special precautions. Accordingly, a further development of the invention not only provides that sealing is applied in the area where electric leads pass through the housing, but also that suitable sealing is provided at the contact areas between the housings, such as gaskets or O-rings, which protect the positioned electric leads against any external environmental influences. Furthermore, according to the invention, it is possible for the openings provided in the housings for the connections also to be closed and sealed, for example by covers. Alternatively, once the connection has been made the electric leads can also be embedded in a hardening sealing mass in the area of the connection points to protect against environmental influences.

It is not necessary for the electric leads to be joined to make actual intimate contact with one another after the housings have been brought together or locked. Within the framework of an advantageous further development of the invention, it is possible to extend the tolerance limits of the lead positions such that, when in place, there is a small gap between the electric leads which is bridged during the subsequent connection forming process.

According to the invention, it is also possible to arrange a plurality of electric leads in fixed positions in the first and second housings, in such a manner that when the housings are brought together there are no wrong connections or short-circuits, i.e., only those electric leads which, in each case, are to be connected to one another, are in contact.

The present objective is also achieved in relation to a method wherein the electric leads to be permanently connected are, in each case, held fixed in a housing and the housings are then brought together in such a manner that guiding means attached on the housings cooperate so that the electric leads contact one another in a defined way. Then, through openings provided in the housings, one or more connection forming devices act upon the electric leads which are correctly positioned relative to one another, for that purpose and which are geometrically shaped and arranged in the housings so that the end areas in contact with one another are freely visible through the openings. In an advantageous further development of the invention, the housings can be provided with additional detent means which lock together when the housings are joined and thereby fix the leads in their predetermined positions.

A very advantageous further development of the invention provides that once the housings have been brought together and locked, a method that results in self-bonding of the material, preferably laser welding, is used to connect the electric leads permanently to one another. Such methods have the advantage that they are among the common connecting methods for electronic components and can be automated and to a large extent technologically well controlled.

In another embodiment of the invention, the positioned electric leads are connected permanently by a process that produces positive shape interlock, such as crimping, and in this case too the connection forming devices can act upon the leads to be connected through openings provided in the housings.

The secure guiding/locking of the housings makes it possible for the electric leads held in them to be shaped and relatively positioned in an optimum way for the connection forming process used, and this eliminates the need for additional process steps, for example for the prior determination of the positions of the electric leads. The openings in the housings provided for the subsequent formation of the connections allow access to the ends of the two electric leads to be connected, whereby the quality of the connection can also be checked out simply. To ensure a lastingly good connection quality, the housings can in addition have suitable sealing means which keep damaging environmental influences away from the connection points.

### BRIEF DESCRIPTION OF THE DRAWINGS

The invention will now be described, by way of example, with reference to the accompanying drawings. The Figures show, represented schematically in each case:

FIG. 1 a partial view of the first and second housings, each with electric leads fixed in place before the housings are brought together, shown in an isometric view in which the housings are brought together along the longitudinal direction of the first electric lead;

FIG. 2 a sectioned view of FIG. 1 in the plane of an electric lead, the housings having been brought together and with the electric leads in contact with one another;

FIG. 3 is another embodiment of the first and second housings, each with electric leads fixed in place before the housings are brought together, shown in an isometric view in which the housings are brought together along the longitudinal direction of the second electric lea;

FIG. 4 is a sectioned view of FIG. 3 with the housings brought together and a connection between electric leads already made through an opening;

FIG. 5A is other possible form of the ends of the electric leads to be connected and their joining direction, not showing the respective housings that surround them;

FIG. 5B is another possible form of the ends of the electric leads to be connected and their joining direction, not showing the respective housings that surround them;

FIG. 6 is an isometric view of the ends of a round and a polygonal electric lead to be connected, and

FIG. 7 is an isometric view of the ends of two polygonal electric leads to be connected.

### DETAILED DESCRIPTION OF THE INVENTION

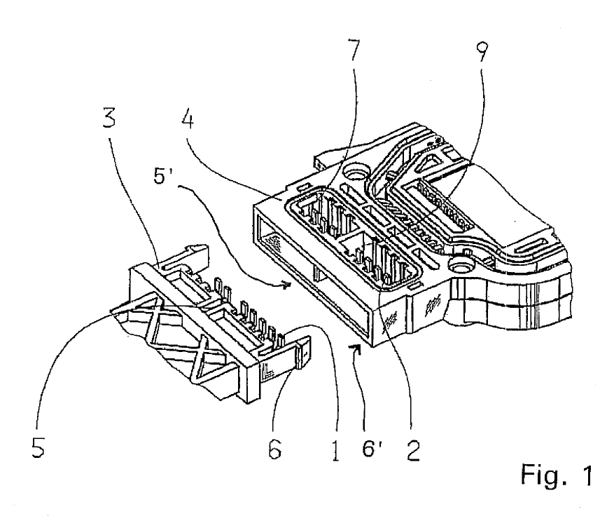

FIG. 1 shows electric leads 1, 2 to be connected, each bedded in fixed positions in respective housings 3 or 4. At its end to be connected the first electric lead 1 has an L-shaped bend and at its end to be connected the second electric lead 2 is straight so that when the housings 3, 4 are brought together the ends will be in contact and can then be permanently connected within a free space 9 to conduct electricity, through a housing opening 7 by way of a connection forming device (not shown). The electric lead 2 runs from outside of the housing 4, where the end to be connected is located, to an inside, which can be sealed by way of a closing cover (not shown here). When the housings 3, 4 are brought together guiding means 5, 5′, which can for example be specially designed housing surfaces or locating pins, ensure that the electric leads 1, 2 are positioned relative to one another in a defined way, while detent means 6, 61 ensure that this positioning is lastingly maintained. The said detent means 6, 6′, besides the clip-type detent illustrated, is able to be of other possible types as well, such as catches. This eliminates the need for other position determination or position fixing measures of the electric leads during the process of forming the connection. The housing opening 7 provided in the second housing 4 for the purpose of forming and checking the joint can be closed by a cover (not shown), which protects the connection against external environmental influences.

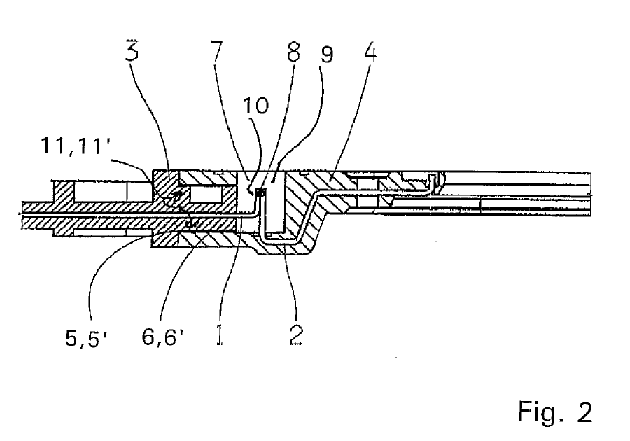

FIG. 2 shows the housings 3, 4 and the electric leads 1, 2 in FIG. 1 when they have already been brought together so that the ends of the electric leads 1, 2 to be connected are in contact with one another. The connection is made in free space 9 and at end faces 8 of the ends of the electric leads by laser welding through the housing opening 7, which also enables the quality of the connection to be checked in a simple way. In this embodiment of the invention, the guide means 5, 5′ and detent means 6, 6′ are made as complementary housing surfaces and sealing surfaces 11, 11′ of housings 3 and 4 seal free space 9 from environmental influences. Preferably, when the housings 3, 4 are held together the electric leads 1, 2 are positioned with a slight gap (not shown here) between them, this allowing the tolerance limits to be increased. A typical value of the gap size is 0.1 mm (3.94 mil). In this embodiment of the invention, the housings 3, 4 are brought together along the longitudinal direction of the first electric lead 1.

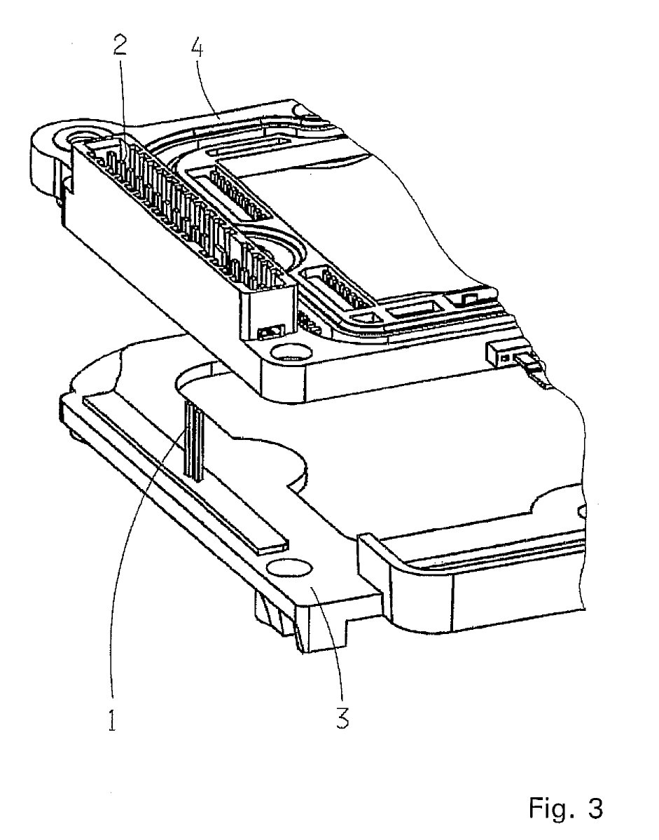

FIG. 3 shows another embodiment, according to the invention, with the electric lead 1 of straight shape held in the first housing 3 and the second electric lead 2, bent in an L-shape at its end to be connected, held in the second housing 4. The housings 3, 4 are brought together with guiding and detent means (not shown) along the longitudinal direction of the first electric lead 1. As shown, the housings 3, 4 can hold more than one electric lead which, for example, allows the connection of electric leads arranged in a row.

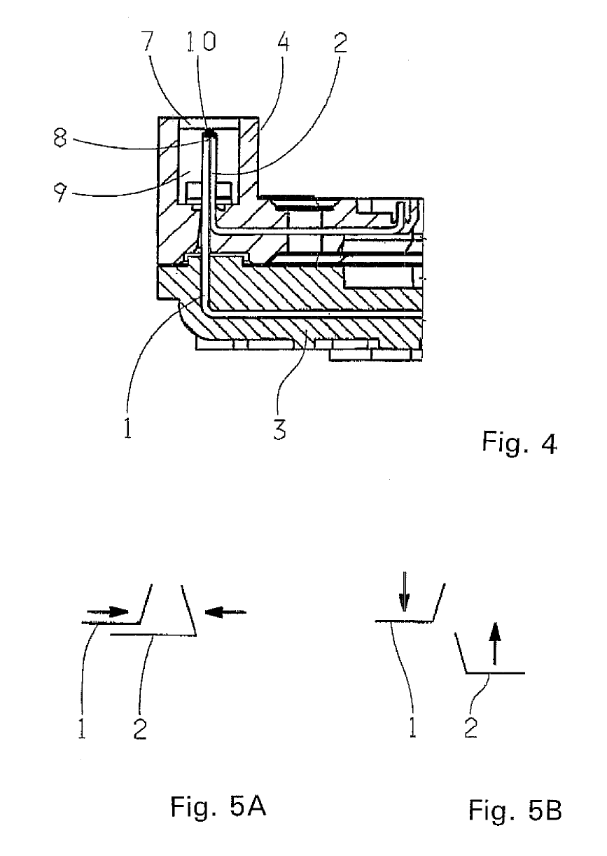

In FIG. 4, the housings 3, 4 shown in FIG. 3 have been brought together into their final position and the connection, between the first and second electric leads 1, 2, has already been formed. On its side facing toward the first housing 3 the second housing 4 has a bore of conical shape, into which the straight electric lead 1 is inserted. This ensures that when the housings 3, 4 are brought together, the first electric lead 1 will be guided along the end of the second electric lead 2 bent into an L-shape so that the ends of the electric leads to be connected are in contact with one another. A connection point 10 is at the face 8 of the ends of the electric leads 1, 2 and its formation takes place in the free space 9 through the housing opening 7 provided in the second housing 4.

FIGS. 5A, 5B show examples of other design forms of the present invention, the electric leads 1, 2 to be connected being shown without the housings that contain them and the relative movement directions imposed by the guide means when the housings are brought together being indicated by arrows. To ensure that the L-shaped ends of the electric leads 1, 2 to be joined are in mutual contact in the final position, they are not bent through an exact right-angle, but are somewhat inclined toward one another so that once the housings have been brought together there is a certain pre-stress between them so that slight bend angle tolerances are compensated.

In the left-hand part of FIG. 5B, when the housings are brought together the longitudinal axes of the electric leads 1, 2 are pushed parallel to one another so that the end of the second electric lead 2 to be connected moves along the end of the first electric lead 1 to be connected during this approach movement. In this it is also possible, according to the invention, for the ends to be in contact in such manner that at least one end of a lead is not involved in the formation of the joint, i.e., the common connection point is for example at the tip of the end of the second electric lead 2 but at a point along the first electric lead 1, so that the connection consists of a so-termed fillet weld.

The right-hand side of FIG. 5A illustrates another design of the invention, suitable for cases when the housings are brought together in the direction of the longitudinal axes of the first and second electric leads 1, 2, so that the electric leads 1, 2 run in the same direction from the connection point.

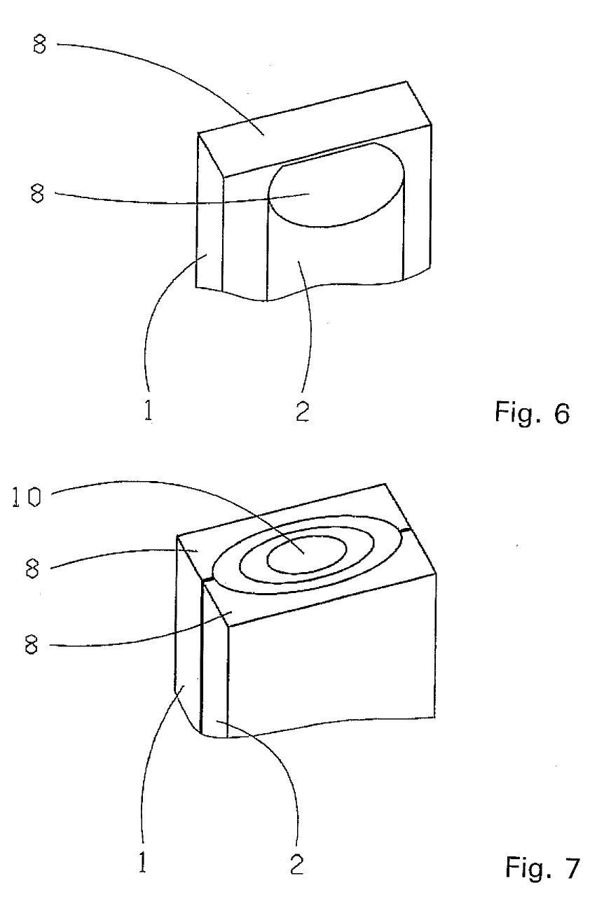

FIG. 6 shows an isometric view of the ends of the first and second electric leads 1, 2 resting in contact with one another. Along its end to be connected the first electric lead 1 has a rectangular cross-section and the second electric lead 2 a rounded cross-section, which is flattened on the side facing toward the first electric lead 1. During the formation of the joint by laser welding, this improves the laser beam's incidence effect in the conducting materials at the tips 8 of the ends of the electric leads, which has a positive result for the quality of the connection.

FIG. 7 shows the already connected ends of the first and second electric leads 1, 2, the ends of the two leads having a rectangular cross-section. In this embodiment of the invention, the electric leads 1, 2 are permanently connected to one another by a connection point 10 made as a laser weld spot on the tip surfaces 8 of the ends. According to the invention, size differences and position differences of the electric leads 1, 2 (not shown here), possibly caused by displacement, are allowable.

### REFERENCE NUMERALS

1 electric lead
2 electric lead
3 housing
4 housing
5, 5′ guiding means
6, 6′ detent means
7 housing opening
8 tip surfaces of the lead ends
9 free space
10 connection point
11, 11′ sealing surfaces

1-20. (canceled)

21. A connection element for connecting electrical leads (1, 2), the element comprising at least a first electric lead (1) and a second electric lead (2), the first electric lead (1) being arranged in a fixed position in a first housing (3) and the second electric lead (2) being arranged in a fixed position in a second housing (4) and the first electric lead (1) and the second electric lead (2) being permanently connected to one another, the first housing (3) having guiding mechanism (5) which, together with a guiding mechanism (5′) of the second housing (4), establish the fixed positions of the first and the second electric leads (1, 2), relative to one another, such that a permanent connection can be made between the first electric lead (1) and the second electric lead (2).

22. The connection element according to claim 21, wherein the first housing (3) has a detent mechanism (6) which, together with a detent mechanism (6′) of the second housing (4), ensure that the fixed positions of the first and the second electric leads (1, 2) relative to one another are maintained.

23. The connection element according to claim 21, wherein the second housing (4) has at least one housing opening (7) providing access to the permanent connection is made between the first and the second electric leads (1, 2).

24. The connection element according to claim 23, wherein the at least one housing opening (7) is closed by at least one cover.

25. The connection element according to claim 21, wherein the first and the second electric leads (1, 2) are positioned in an inside space (9) formed by bringing the first and the second housings (3, 4) together, and the first housing (3) has sealing surfaces 11 which cooperate with sealing surfaces 11′ of the second housing (4), the inside space is sealed against environmental influences that act upon an outside of the first and the second housings (3, 4).

26. The connection element according to claim 21, wherein the first and second housings (3, 4) have a connection point (10) that is embedded in a sealing mass such that the connection point (10) is sealed against surrounding environmental influences.

27. The connection element according to claim 21, wherein one of the first electric lead (1) extends from a first side of the first housing (3) to a second side of the first housing (3) and the second electric lead (2) extends from a first side of the second housing (4) to a second side of the second housing (4).

28. The connection element according to claim 27, wherein one of the first and the second electric leads (1, 2) has a rounded cross-section at least in an area passing through a respective one of the first and the second housings (3, 4).

29. The connection element according to claim 27, wherein a sealing mechanism is arranged between the first and the second electric leads (1, 2) and the first and the second housings (3, 4) in an area passing through a respective one of the first and the second housings (3, 4).

30. The connection element according to claim 29, wherein the sealing mechanism comprises a glass-type structure.

31. The connection element according to claim 21, wherein a small gap exists between the first and the second electric leads (1, 2) when the first and the second housings (3, 4) are connected.

32. The connection element according to claim 21, wherein a first end of the first electric lead (1) has an L-shape.

33. The connection element according to claim 32, wherein a first end of the second electric lead (2) has an L-shape, the guiding mechanism (5) of the first housing (3) and the guiding mechanism (5) of the second housing (4) are formed in a manner such that when the first and the second housings (3, 4) are coupled, a longitudinal axes of the first and the second electric leads (1, 2) are moved parallel to one another, the first end of the first electric lead (1) and the first end of the second electric lead (2) initially connect and thereafter are permanently connected.

34. The connection element according to claim 32, wherein the first end of the second electric lead (2) is one of straight and L-shaped, and the guiding mechanism (5) are formed in such manner that the first and the second housings (3, 4) are brought together along a longitudinal axis of the first and the second electric leads (1, 2) so that the first end of the first electric lead (1) and the first end of the second electric lead (2) initially connect and thereafter are permanently connected.

35. The connection element according to claim 21, wherein one of the first and the second electric leads (1, 2) has a rounded cross-section.

36. The connection element according to claim 21, wherein one of the first and the second electric leads (1, 2) has a flattened area on a side facing toward the connection point (10).

37. An electrical connection element comprising:
at least one first electrical lead (1) fixed within a first housing (3), and the first housing (3) having a guide (5);
at least one second electric lead (2) fixed within a second housing (4), and the second housing (4) having a guide (5′);
the guide (5) of the first housing (3) and the guide (5′) of the second housing (4) direct the first electrical lead (1) into connection with the second electrical guide (2) at a connection point (10);
an opening (7) in the second housing (4) enabling access to the connection point (10), which is located within the first housing (3), when the first housing (3) is connected to the second housing (4); and
one of the first and the second electric leads (1, 2) has a polygonal cross-section, at least along the first end.

38. A method of connecting a connecting element comprising at least a first electric lead (1) and a second electric lead (2), the first electric lead (1) being arranged in a fixed position in a first housing (3) and the second electric lead (2) being arranged in a fixed position in a second housing (4) and the first electric lead (1) and the second electric lead (2) being permanently connected to one another, the first housing (3) having a guiding mechanism (5) which, together with a guiding mechanism (5) of the second housing (4), establishes the fixed positions of the first and the second electric leads (1, 2), relative to one another, such that a permanent connection can be made between the first electric lead (1) and the second electric lead (2), the method comprising the steps of:
slidably engaging the guiding mechanism (5) of the first housing (3) with the guiding mechanism (5) of the second housing (4) until an end position is reached, and
permanently connecting the first and the second electric leads (1, 2) with one another.

39. The method of connecting the connecting element according to claim 38, further comprising the step of permanently connecting the first and the second electric leads (1, 2) by laser welding.

40. The method of connecting the connecting element according to claim 38, further comprising the step of permanently connecting the first and the second electric leads (1, 2) by crimping.
